(19) United States
(12) Patent Application Publication
(10) Pub. No.: US 2026/0116067 A1
(43) Pub. Date: Apr. 30, 2026

(54) PRINTING APPARATUS, PRINTING METHOD AND NON-TRANSITORY COMPUTER-READABLE RECORDING MEDIUM THEREFOR

(71) Applicant: BROTHER KOGYO KABUSHIKI KAISHA, Nagoya (JP)

(72) Inventor: Kohei KANEHARA, Nagoya (JP)

(73) Assignee: BROTHER KOGYO KABUSHIKI KAISHA, Nagoya (JP)

(21) Appl. No.: 19/371,907

(22) Filed: Oct. 28, 2025

(30) Foreign Application Priority Data
Oct. 31, 2024 (JP) 2024-192173

(51) Int. Cl. B41J 2/045; B41J 2/14

(52) U.S. Cl. CPC B41J 2/04588; B41J 2/04541; B41J 2/04581; B41J 2/04596; B41J 2/14233

(57) ABSTRACT

A printing apparatus includes a nozzle configured to eject liquid from a pressure chamber by an energy applying element, a controller configured to generate a first drive waveform including an ejection waveform, and a detection circuit configured to detect a residual pressure wave in a case where the residual pressure wave occurs in the pressure chamber. A detection result from the detection circuit is input to the controller, and the controller is configured to generate a second drive waveform including a corrected ejection waveform obtained by correcting the ejection waveform based on the detection result from the detection circuit.

### REFERENCE TO RELATED APPLICATIONS

This application claims priority under 35 U.S.C. § 119 from Japanese Patent Application No. 2024-192173 filed on Oct. 31, 2024. The entire subject matter of the application is incorporated herein by reference.

### BACKGROUND ART

The present disclosure relates to a printing apparatus configured to eject liquid from nozzles, a printing method, and a non-transitory computer-readable recording medium.

Conventionally, there is known an inkjet recording device that includes a nozzle for ejecting liquid, a pressure chamber in communication with the nozzle, and a piezoelectric actuator that applies pressure fluctuation to the ink in the pressure chamber. The inkjet recording device generates non-ejection vibration pulses that apply pressure fluctuations to the ink in the pressure chamber in such a manner that the ink is prevented from being ejected from the nozzle. For example, in accordance with the temperature of the ink, the piezoelectric actuator is driven by the non-ejection vibration pulses to stir the ink in the pressure chamber, thereby suppressing temperature variations in the pressure chamber.

### SUMMARY

The waveform of an ejection pulse for ejecting liquid may vary depending on environmental factors such as temperature or humidity, or on the characteristics of components for ejecting the liquid, such as the nozzle and the pressure chamber. Therefore, for example, there is a possibility that the amount and speed of the ejected liquid may fluctuate.

According to aspects of the present disclosure, a printing apparatus include a nozzle configured to eject liquid from a pressure chamber by an energy applying element, a controller configured to generate a first drive waveform used to drive the energy applying element, the first drive waveform including an ejection waveform used to eject liquid from the nozzle, and a detection circuit configured to detect a residual pressure wave in a case where the residual pressure wave occurs in the pressure chamber after the energy applying element is driven based on the first drive waveform. A detection result from the detection circuit is input to the controller, and the controller is configured to generate a second drive waveform including a corrected ejection waveform obtained by correcting the ejection waveform based on the detection result from the detection circuit.

According to aspects of a present disclosure, a printing method is a method of controlling the printing apparatus where liquid in a pressure chamber is ejected through a nozzle by an energy applying element. The printing method includes generating a first drive waveform used to drive the energy applying element, the first drive waveform including an ejection waveform used to eject liquid from the nozzle, detecting a residual pressure wave in a case where the residual pressure wave occurs in the pressure chamber after the energy applying element is driven based on the first drive waveform, and generating a second drive waveform including a corrected ejection waveform obtained by correcting the ejection waveform based on a detection result of the residual pressure wave.

According to aspects of the present disclosure, a non-transitory computer-readable recording medium containing computer-executable instructions that are executable by a controller of a printing apparatus. The printing apparatus being configured to ejects liquid from a pressure chamber through a nozzle by an energy applying element. The computer-executable instructions is configured to, when executed by the controller, cause the printing apparatus to perform generating a first drive waveform used to drive the energy applying element, the first drive waveform including an ejection waveform used to eject liquid from the nozzle, detecting a residual pressure wave in a case where the residual pressure wave occurs in the pressure chamber after the energy applying element is driven based on the first drive waveform, and generating a second drive waveform including a corrected ejection waveform obtained by correcting the ejection waveform based on a detection result of the residual pressure wave.

### BRIEF DESCRIPTION OF THE DRAWINGS

FIG. 1 is a plan view schematically illustrating a printing apparatus.

FIG. 2 is an enlarged sectional view schematically illustrating a portion of an inkjet head.

FIG. 3 is a block diagram of a controller.

FIG. 4 is a conceptual diagram showing a drive waveform.

FIG. 5 is a circuit diagram schematically illustrating configuration of an amplifier.

FIG. 6 is a block diagram schematically illustrating the configuration of the control circuit and the memory.

FIG. 7 is a graph schematically illustrating an ejection waveform.

FIG. 8 is a graph schematically illustrating a residual pressure wave.

FIG. 9 is a graph schematically illustrating the residual pressure wave and a pressure wave after a model identified.

FIG. 10 is a graph schematically illustrating the pressure wave and a target pressure wave.

FIG. 11 is a graph schematically illustrating a corrected ejection waveform.

FIG. 12 is a graph schematically illustrating a corrected drive waveform.

### DESCRIPTION

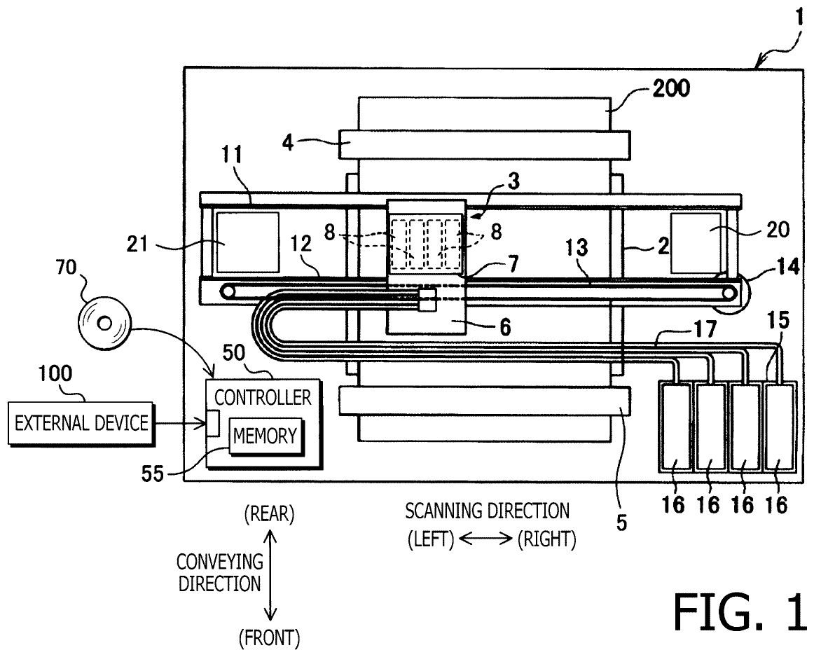

Hereinafter, a printing apparatus according to an embodiment according to aspects of the present disclosure will be described with reference to drawings. FIG. 1 is a plan view schematically illustrating the printing apparatus. In the following description, the front, rear, left, and right directions shown in FIG. 1 are used for explanation. The front-rear direction corresponds to the conveying direction, and the left-right direction corresponds to the scanning direction. The front side in FIG. 1 corresponds to the upper side, and the back side corresponds to the lower side, and the terms “upper” and “lower” are also used as directions.

As shown in FIG. 1, the printing apparatus 1 includes a platen 2, an ink ejection unit 3, and conveying rollers 4 and 5. A recording sheet 200, which is a recording medium, is placed on the upper surface of the platen 2. The ink ejection unit 3 ejects ink onto the recording sheet 200 placed on the platen 2 to record an image. The ink ejection unit 3 includes a carriage 6, a sub tank 7, four inkjet heads 8, a circulation pump (not shown), and the like.

Two guide rails 11 and 12 extending in the left-right direction are provided above the platen 2 to guide the carriage 6. An endless belt 13 extending in the left-right direction is connected to the carriage 6. The endless belt 13 is driven by a carriage drive motor 14. Driven by the endless belt 13, the carriage 6 is guided by the guide rails 11 and 12 and reciprocally moves in the scanning direction in an area facing the platen 2. Specifically, the carriage 6 supports the four inkjet heads 8 and performs a first movement that moves the heads from a particular position to another in the scanning direction from left to right, and a second movement that moves the heads from another position to the particular position in the opposite direction from right to left.

Between the guide rails 11 and 12, a cap 20 and a flushing receiver 21 are provided. The cap 20 and the flushing receiver 21 are positioned below the ink ejection unit 3. The cap 20 is arranged at the right end of the guide rails 11 and 12, and the flushing receiver 21 is arranged at the left end of the guide rails 11 and 12. Note that the positions of the cap 20 and the flushing receiver 21 may be reversed left to right.

The sub tank 7 and the four inkjet heads 8 are mounted on the carriage 6 and reciprocates in the scanning direction together with the carriage 6. The sub tank 7 is connected to a cartridge holder 15 via a tube 17. Ink cartridges 16 of one or more colors (four colors in this embodiment) are mounted in the cartridge holder 15. The four colors may be black, yellow, cyan, and magenta.

Inside the sub tank 7, four ink chambers (not shown) are formed. The four ink chambers respectively store the four colors of ink supplied from the four ink cartridges 16.

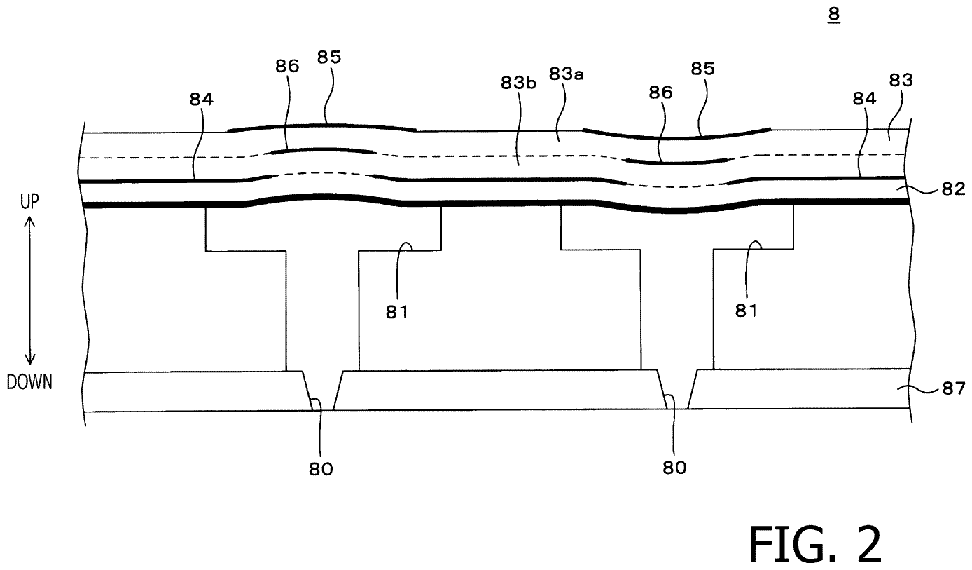

The four inkjet heads 8 are aligned in the scanning direction under the sub tank 7. A plurality of nozzles 80 are formed on the bottom surface of each inkjet head 8 (see FIG. 2). Each inkjet head 8 corresponds to one ink color and is connected to one ink chamber. That is, the four inkjet heads 8 respectively correspond to the four colors of ink and are connected to the four ink chambers, respectively.

Each inkjet head 8 is provided with an ink supply port and an ink discharge port. The ink supply port and the ink ejection port are connected to the ink chambers via tubes or the like. A circulation pump is provided between the ink supply port and the ink chamber.

Ink supplied from the ink chamber by the circulation pump flows into the inkjet head 8 through the ink supply port and is ejected from the nozzles 80. Ink ejected from the nozzles 80 returns to the ink chamber through the ink ejection port. The ink circulates between the ink chambers and the inkjet heads 8. While the four inkjet heads 8 move in the scanning direction together with the carriage 6, the four inkjet heads 8 eject the four colors of ink supplied from the sub tank 7 onto the recording sheet 200, respectively.

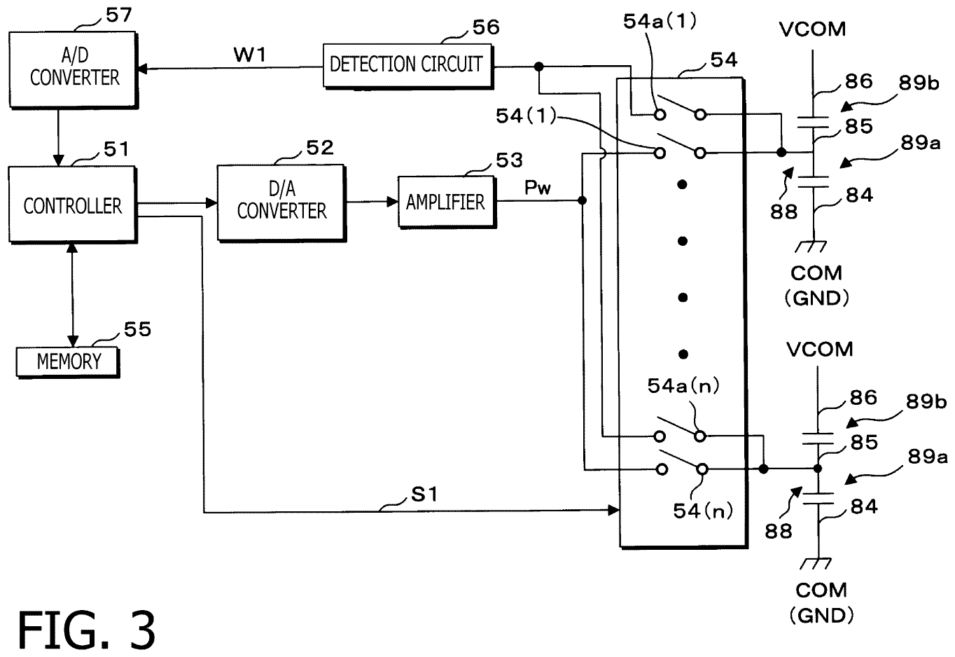

As shown in FIG. 1, the conveying roller 4 is arranged at upstream (rear side) in the conveying direction relative to the platen 2. The conveying roller 5 is disposed downstream (front side) in the conveying direction relative to the platen 2. The two conveying rollers 4 and 5 are driven synchronously by a motor (not shown). The two conveying rollers 4 and 5 convey the recording sheet 200 placed on the platen 2 in the conveying direction, which is orthogonal to the scanning direction. The printing apparatus 1 includes a controller 50. The controller 50 includes a control circuit 51 (see FIG. 3) having a CPU or a logic circuit (e.g., FPGA or ASIC), a main storage unit, and an auxiliary storage unit (not shown).

The control circuit 51 executes various processing tasks such as a computing process or a control process. These multiple processes may be executed by a single processor or logic circuit included in the control circuit 51, or executed in a distributed manner by multiple processors or logic circuits provided in the control circuit 51. A processor or a logic circuit that executes one process and a processor or a logic circuit that executes another process may be provided separately. The main storage unit is, for example, a memory 55 such as a nonvolatile memory or an RAM. Examples of the auxiliary storage unit include a ROM and a rewritable storage medium such as an EEPROM, a flash ROM, or a hard disk drive. The control program is stored in the auxiliary storage unit.

The control circuit 51 reads the control program from the auxiliary storage unit into the main storage unit and executes the read control program. The control program may be installed in the auxiliary storage unit from a recording medium 70, such as an optical disc or a portable flash memory. Alternatively, the control circuit 51 may download the control program from an external device 100 to the auxiliary storage unit via a network. Processes executed by the control program, such as a printing process or a flushing process, may also be executed as distributed processes executed by the control circuit 51, an external device 100 or a terminal (not shown).

The controller 50 receives a print job and drive waveform data from the external device 100. The memory 55 stores the received print job and the drive waveform data.

Based on the print job, the controller 50 controls driving of the ink ejection unit 3 and the conveying rollers 4, etc., and performs the printing process.

FIG. 2 is an enlarged sectional view schematically illustrating a portion of the inkjet head 8. The inkjet head 8 includes a plurality of pressure chambers 81. A vibration plate 82 is formed on the upper side of the pressure chambers 81. A layered piezoelectric element 83 is formed on the upper side of the vibration plate 82. The piezoelectric element 83 includes an upper piezoelectric layer 83a and a lower piezoelectric layer 83b. On the upper side of each pressure chamber 81, a first common electrode 84 is formed between the piezoelectric element 83 and the vibration plate 82.

Inside the piezoelectric element 83, specifically between the upper piezoelectric layer 83a and the lower piezoelectric layer 83b, a second common electrode 86 is provided. The second common electrode 86 is disposed above each pressure chamber 81 and above the first common electrode 84. The second common electrode 86 is arranged at a position that does not face the first common electrode 84. An individual electrode 85 is formed above each pressure chamber 81 and on the upper surface of the piezoelectric element 83. The individual electrode 85 and the first common electrode 84 and the second common electrode 86 face each other vertically across the piezoelectric element 83. The vibration plate 82, the piezoelectric element 83, the first common electrode 84, the individual electrode 85, and the second common electrode 86 constitute an actuator 88. The actuator 88 serves as an energy applying element.

A nozzle plate 87 is provided at the lower portion of each pressure chamber 81. A plurality of nozzles 80 penetrating vertically are formed in the nozzle plate 87. Each nozzle 80 is arranged below each pressure chamber 81.

The first common electrode 84 is connected to a COM terminal, which is ground in this embodiment, and the second common electrode 86 is connected to a VCOM terminal. The VCOM voltage is higher than the COM voltage. The individual electrode 85 is connected to a switching driver 54 (see FIG. 3). When a High or Low voltage is applied to the individual electrode 85, the piezoelectric element 83 deforms, and the vibration plate 82 vibrates. Due to the vibration of the vibration plate 82, liquid ink is ejected from the pressure chamber 81 through the nozzle 80.

The individual electrode 85 corresponds to a first electrode, the second common electrode 86 corresponds to a second electrode, and the first common electrode 84 corresponds to a third electrode. The vibration plate 82 corresponds to a third piezoelectric layer. In other words, the actuator 88 has a three-layer structure.

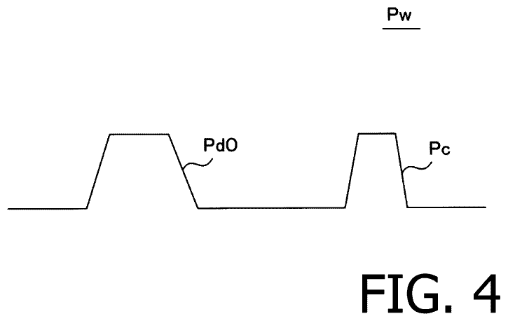

FIG. 3 is a block diagram of the controller 50, and FIG. 4 is a conceptual diagram showing a drive waveform Pw. The controller 50 includes a control circuit 51, a D/A converter 52, an amplifier 53, a switching driver 54, a memory 55, a detection circuit 56, and an A/D converter 57. The memory 55 stores drive waveform data. The drive waveform data represents a voltage waveform applied to the individual electrodes 85, that is, data indicating a drive waveform for driving the actuator 88, and is quantized data. The drive waveform represented by the drive waveform data corresponds to a first drive waveform. The control circuit 51, the D/A converter 52, the amplifier 53, and the memory 55 correspond to the controller.

The D/A converter 52 converts digital signals into analog signals. The amplifier 53 is an amplification circuit that amplifies the analog signals. In the present embodiment, a self-oscillating Class D amplifier is used as the amplifier 53. However, instead of the self-oscillating Class D amplifier, a hetero-oscillating Class D amplifier may be used. The switching driver 54 includes a plurality of n-th switches 54(n) (n=1, 2, . . . ). Each n-th switch 54 (n) is, for example, an analog switch IC. One end of each of the plurality of n-th switches 54 (n) is connected to the amplifier 53 via a common bus. The other end of each n-th switch 54 (n) is connected to a respective individual electrode 85 corresponding to the plurality of nozzles 80. That is, one n-th switch 54 (n) is provided for each actuator 88.

The switching driver 54 includes a plurality of detection switches 54a (n) (n=1, 2, . . . ). Each detection switch 54a (n) includes, for example, an analog switch IC. One end of each of the plurality of detection switches 54a (n) is connected to the detection circuit 56 via a common bus. The other end of each detection switch 54a (n) is connected to a respective individual electrode 85 corresponding to the plurality of nozzles 80. That is, one detection switch 54a (n) is provided for each actuator 88.

A first capacitor 89a is formed by the individual electrode 85, the first common electrode 84, and the piezoelectric element 83. A second capacitor 89b is formed by the individual electrode 85, the second common electrode 86, and the piezoelectric element 83.

The control circuit 51 outputs a switch control signal S1 to the switching driver 54 to control the opening and closing of the plurality of n-th switches 54 (n) and the plurality of detection switches 54a (n). When driving the actuator 88 corresponding to the n-th switch 54 (n), the control circuit 51 outputs a switch control signal S1 for closing the n-th switch 54 (n) and outputs the drive waveform data to the D/A converter 52. The n-th switch 54 (n) is closed, and the actuator 88 is connected to the amplifier 53. The drive waveform data is converted into an analog signal, i.e., the drive waveform Pw, by the D/A converter 52. The drive waveform Pw is amplified by the amplifier 53 and input to the actuator 88 corresponding to the n-th switch 54 (n). The actuator 88 is driven based on the drive waveform Pw, and ink is ejected from the nozzle 80. The state where the n-th switch 54 (n) is closed corresponds to a first connection state.

As shown in FIG. 4, the drive waveform Pw includes an ejection waveform Pd0 for ejecting ink from the nozzle 80, and a cancel waveform Pc for attenuating a residual pressure wave W1 based on the ejection waveform Pd0. The residual pressure wave W1 is a pressure wave that remains in the pressure chamber 81 even after ink (liquid) is ejected from the pressure chamber 81 through the nozzle 80 by a main pressure wave generated by the driving of the actuator 88 and propagated through the pressure chamber 81. In other words, The residual pressure wave W1 is a pressure wave that remains in the pressure chamber 81. The cancel waveform Pc is generated after the ejection waveform Pd0 is generated. The ejection waveform Pd0 is different from the cancel waveform Pc. That is, the amplitude or frequency of the ejection waveform Pd0 is different from that of the cancel waveform Pc, and a waveform shapes of the ejection waveform Pd0 is also different from that of the cancel waveform Pc. The cancel waveform Pc serves to suppress the vibration of the residual pressure wave W1. By the cancel waveform Pc, the residual pressure wave W1 remaining in the pressure chamber 81 is attenuated, thereby suppressing the amplification or attenuation of the main pressure wave based on the next ejection waveform Pd0.

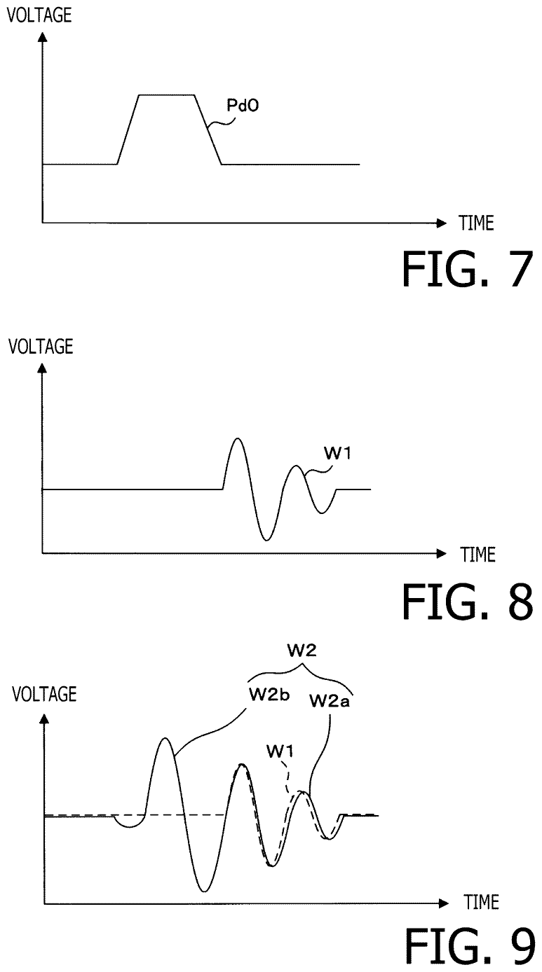

When detecting the residual pressure wave W1 (see FIG. 8) that occurs in the pressure chamber 81 after the actuator 88 corresponding to the n-th switch 54 (n) is driven, the control circuit 51 outputs a switch control signal S1 that closes the detection switch 54a (n). Then, the detection switch 54a (n) is closed. That is, the actuator 88 is connected to the detection circuit 56. At this time, the other detection switches 54a(1) to 54a (n-1) are opened. The detection circuit 56 detects the residual pressure wave W1 (see FIG. 7) that occurs in the pressure chamber 81 after the actuator 88 is driven. The detected residual pressure wave W1 is an analog signal. The detection circuit 56 outputs the residual pressure wave W1 to the A/D converter 57. The A/D converter 57 converts the analog signal of the residual pressure wave W1 into a digital signal and outputs it to the control circuit 51. The state in which the detection switch 54a (n) is closed corresponds to the second connection state.

Note that a plurality of the detection circuits 56 corresponding to the respective detection switches 54a(1) to 54a (n), respectively, may be provided. In this case, it is possible to detect the residual pressure wave W1 simultaneously by closing the plurality of detection switches 54a(1) to 54a (n).

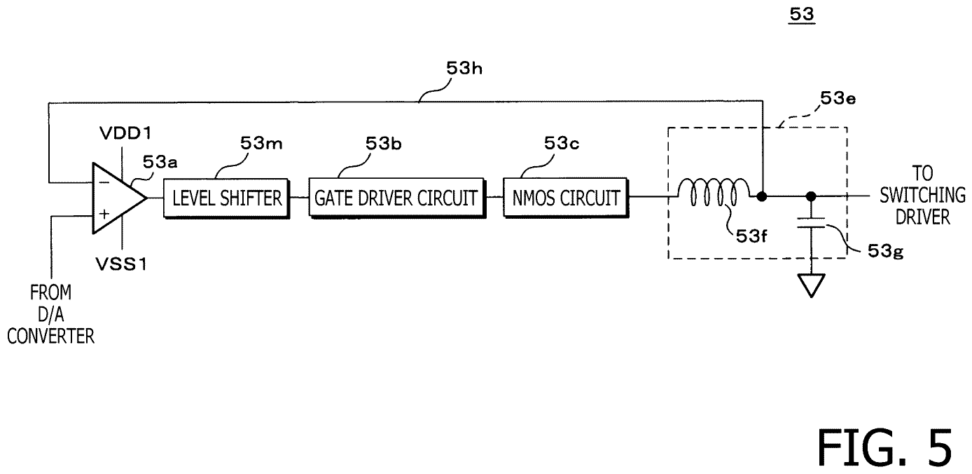

FIG. 5 is a circuit diagram schematically illustrating the configuration of the amplifier 53. The amplifier 53 is a self-oscillating digital amplifier. The amplifier 53 includes a comparator 53a, a level shifter 53m, a gate driver circuit 53b, an NMOS circuit 53c, a low-pass filter 53e, and a negative feedback line 53h.

A positive power supply VDD1 and a negative power supply VSS1 are connected to the comparator 53a. That is, since the comparator 53a is connected to both the positive power supply VDD1 and the negative power supply VSS1, it has a dual power supply configuration. A positive power supply VDD2 and a negative power supply VSS2 are connected to the NMOS circuit 53c. The level shifter 53m, which includes, for example, a Zener diode, changes the level of the signal input from the comparator 53a to correct the voltage difference between the reference voltages of the negative power supplies VSS1 and VSS2.

The positive input terminal of the comparator 53a is connected to the D/A converter 52, and an analog signal from the D/A converter 52 is input to the positive input terminal of the comparator 53a. The output terminal of the comparator 53a is connected to the gate driver circuit 53b via the level shifter 53m, and the signal level of the output signal of the comparator 53a is changed by the level shifter 53m and input to the gate driver circuit 53b. The gate driver circuit 53b is connected to the NMOS circuit 53c and outputs an ON or OFF signal to the NMOS circuit 53c based on the output signal from the comparator 53a. The NMOS circuit 53c is driven by the ON or OFF signal from the gate driver circuit 53b and outputs a signal to the low-pass filter (LPF) 53e.

The low-pass filter 53e includes an inductor 53f and a capacitor 53g. One end of the inductor 53f is connected to the NMOS circuit 53c, and the other end is connected to one end of the capacitor 53g. The other end of the capacitor 53g is connected to ground. The other end of the inductor 53f and one end of the capacitor 53g are connected to the switching driver 54. That is, the low-pass filter 53e outputs the amplified analog signal, i.e., the drive waveform, to the switching driver 54. One end of the negative feedback line 53h is connected to the other end of the inductor 53f and one end of the capacitor 53g, and the other end of the negative feedback line 53h is connected to the negative input terminal of the comparator 53a.

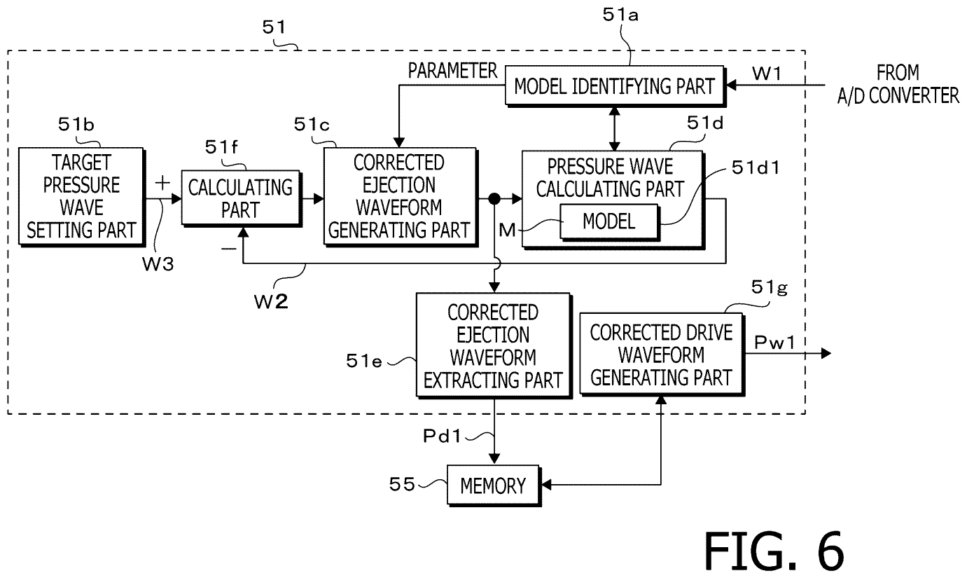

FIG. 6 is a block diagram schematically showing the configuration of the control circuit 51 and the memory 55. FIG. 7 is a graph schematically showing the ejection waveform Pd0. FIG. 8 is a graph schematically showing the residual pressure wave W1. FIG. 9 is a graph schematically showing the residual pressure wave W1 and a pressure wave W2 after a model is identified. As shown in FIG. 6, the control circuit 51 includes a model identification unit 51a, a target pressure wave setting unit 51b, a corrected ejection waveform generation unit 51c, a pressure wave calculation unit 51d, a corrected ejection waveform extraction unit 51e, a calculation unit 51f, and a corrected drive waveform generation unit 51g.

As shown in FIG. 7, when the actuator 88 is driven by the ejection waveform Pd0, the residual pressure wave W1 is generated in the pressure chamber 81, as shown in FIG. 8. By the residual pressure wave, the vibration plate 82 and the piezoelectric element 83 are vibrated, and a voltage waveform is generated. That is, the residual pressure wave is expressed as a voltage waveform. Likewise, the pressure wave is also expressed as voltage waveforms. The pressure wave calculation unit 51d includes a storage unit 51d1, which stores a model M. An initial model is pre-stored in the storage unit 51dl of the pressure wave calculation unit 51d. The model M is a transfer function indicating the relationship between the ejection waveform and the pressure wave. That is, when the residual pressure wave W1 is input to the model identification unit 51a, the model identification unit 51a identifies particular parameters of the transfer function. The model identification unit 51a then outputs the identified parameters to the corrected ejection waveform generation unit 51c. When the ejection waveform is input to the pressure wave calculation unit 51d, the pressure wave calculation unit 51d calculates and outputs a pressure wave, including the residual pressure wave, based on the model M and the ejection waveform. The pressure wave output by the pressure wave calculation unit 51d includes both the residual pressure wave and the main pressure wave, which is generated by the actuator 88 being driven by the ejection waveform and propagates within the pressure chamber 81.

In the present embodiment, a transfer function G of the model is a second-order delay system and includes a fundamental wave transfer function G0 and a transfer function G(m)(m=1, 2, . . . ) of a plurality of harmonic waves. The transfer function G is expressed by the following Equations (1) and (2):

$$G = G 0 + G ( m ) \qquad Equation ( 1 )$$

$$G ( m ) = G ( 1 ) + G ( 2 ) + … \qquad Equation ( 2 )$$

The fundamental wave transfer function G0 is expressed by the following Equation (3), and the harmonic transfer function Gm is expressed by the following Equation (4):

$$G 0 = ( ( {K}_{0} \cdot {ω}_{0} ) / ( {s}^{2} + 2 {ζ}_{0} {ω}_{0} s + {{ω}_{0}}^{2} ) ) \cdot {e}^{- L 0 s} \qquad Equation ( 3 )$$

$$G ( m ) = ( ( {K}_{m} \cdot {ω}_{m} ) / ( {s}^{2} + 2 {ζ}_{m} {ω}_{m} s + {{ω}_{m}}^{2} ) ) \cdot {e}^{- L m s} \qquad Equation ( 4 )$$

Here, K₀ and Kₘ indicate gains, ω₀ and ωₘ indicate resonance frequencies, ζ₀ and ζₘ indicate damping ratios, and L0 and Lm indicate dead time lengths.

The residual pressure wave detected by the detection circuit 56 is output from the A/D converter 57 to the model identification unit 51a. The information related to the residual pressure wave input to the model identification unit 51a via the A/D converter 57 is a digital signal. For example, as shown in FIG. 9, when the residual pressure wave W1 is input, the model identification unit 51a identifies a model in such a manner that a pressure wave W2, which includes a residual pressure wave W2a corresponding to the residual pressure wave W1, is output. Specifically, the model identification unit 51a adjusts parameters such as gains K₀, Kₘ, resonance frequencies ω₀, ωₘ, and damping ratios ζ₀, ζₘ, and identifies the model. That is, if there are multiple candidate pressure waves W2 that include a residual pressure wave identical or similar to the residual pressure wave W1, the model identification unit 51a narrows down the candidates to one. In other words, based on the residual pressure wave W1, the model identification unit 51a determines one pressure wave W2 from among the candidates. The parameters are stored in the memory 55. The pressure wave W2 includes the residual pressure wave W2a and the main pressure wave W2b, which is generated by the actuator 88 being driven by the ejection waveform and propagates through the pressure chamber 81. Note that the transfer function G of the model is not limited to a second-order delay system, it may be a first-order delay system or a higher-order delay system, such as a third-order or greater system.

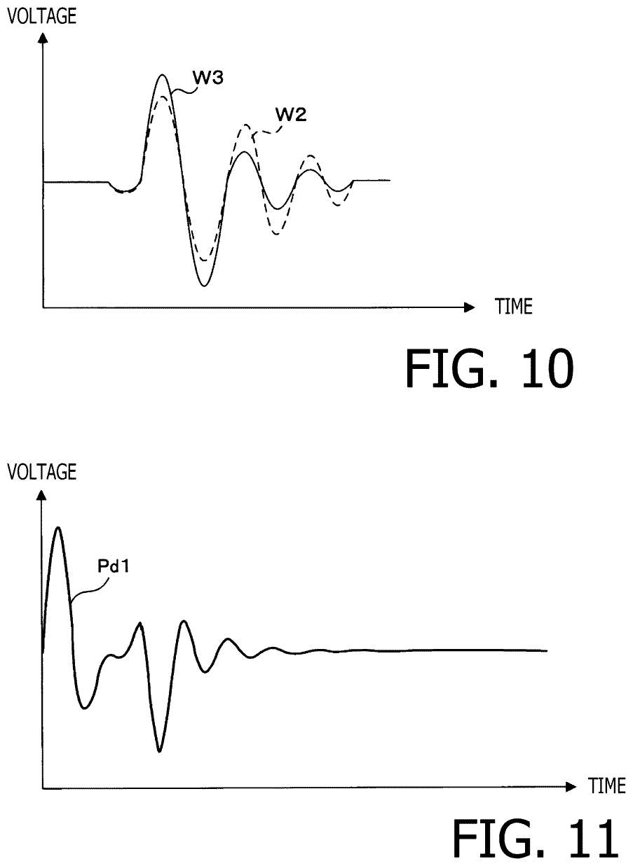

FIG. 10 is a graph schematically showing the pressure wave W2 and a target pressure wave W3.

After identifying the model and the pressure wave W2, the model identification unit 51a outputs the identified parameters such as gains K₀, Kₘ, resonance frequencies ω₀, ωₘ, and damping ratios ζ₀, ζₘ to the corrected ejection waveform generation unit 51c. The target pressure wave setting unit 51b outputs the target pressure wave W3 to the calculation unit 51f. The output of the pressure wave calculation unit 51d, i.e., the output of the model, is input to the calculation unit 51f. The calculation unit 51f calculates the difference between the target pressure wave W3 and the output of the model (i.e., the pressure wave W2) and outputs the calculation result to the corrected ejection waveform generation unit 51c. Based on the input difference, the corrected ejection waveform generation unit 51c generates a corrected ejection waveform Pd1 and outputs the corrected ejection waveform Pd1 to the pressure wave calculation unit 51d. The pressure wave calculation unit 51d outputs a pressure wave in response to the input of the corrected ejection waveform Pd1. The output of the pressure wave calculation unit 51d is fed back and output to the calculation unit 51f. Note that the corrected ejection waveform generation unit 51c repeatedly generates the corrected ejection waveform Pd1 and outputs it to the pressure wave calculation unit 51d until the difference between the target pressure wave W3 and the output of the pressure wave calculation unit 51d, calculated by the calculation unit 51f, becomes equal to or less than a particular value.

The corrected ejection waveform generation unit 51c generates the corrected ejection waveform Pd1 using the parameters and the target pressure wave W3. The corrected ejection waveform extraction unit 51e extracts the corrected ejection waveform Pd1 generated by the corrected ejection waveform generation unit 51c and outputs the extracted corrected ejection waveform Pd1 to the memory 55. The memory 55 stores the corrected ejection waveform Pd1.

The corrected ejection waveform generation unit 51c adjusts the parameters (e.g., gains K₀, Kₘ, resonance frequencies ω₀, ωₘ, and damping ratios ζ₀, ζₘ) in such a manner that, for example, the amplitude of the residual pressure wave in the target pressure wave W3 becomes smaller than the amplitude of the residual pressure wave W2a. This makes it possible to reduce the influence of the residual pressure wave on the ink condition in the pressure chamber 81.

The corrected ejection waveform generation unit 51c generates the corrected ejection waveform Pd1 by correcting the target pressure wave W3 based on the difference, such that the amplitude of the main pressure wave in the target pressure wave W3 becomes equal to the amplitude of the main pressure wave W2b in the pressure wave W2. Herein, the difference relates the detection result of the detection circuit 56. If the amplitude of the main pressure wave W2b is smaller than the amplitude of the main pressure wave intended to be realized by the ejection waveform Pd0, the amplitude of the main pressure wave W2b in the pressure wave W2 is increased so as to match the amplitude of the main pressure wave in the target pressure wave W3, thereby allowing ink to be ejected from the nozzle 80 in the desired amount and at the desired speed. On the other hand, if the amplitude of the main pressure wave W2b is greater than the amplitude of the main pressure wave intended to be realized by the ejection waveform Pd0, the amplitude of the main pressure wave W2b in the pressure wave W2 is decreased to match the amplitude of the main pressure wave in the target pressure wave W3, thereby allowing ink to be ejected from the nozzle 80 in the desired amount and at the desired speed.

FIG. 11 is a graph schematically showing the corrected ejection waveform Pd1. The corrected ejection waveform extraction unit 51e extracts the corrected ejection waveform Pd1 generated by the corrected ejection waveform generation unit 51c and outputs the extracted corrected ejection waveform Pd1 to the memory 55. The memory 55 stores the corrected ejection waveform Pd1. The amplitude, frequency, and shape of the corrected ejection waveform Pd1 are different from those of the ejection waveform Pd0. Note that, only the amplitude of the corrected ejection waveform Pd1 may be different from the ejection waveform Pd0, only the frequency of the corrected ejection waveform Pd1 may be different from the discharge waveform Pd0, and only the shape of the corrected discharge waveform Pd1 may be different from the discharge waveform Pd0.

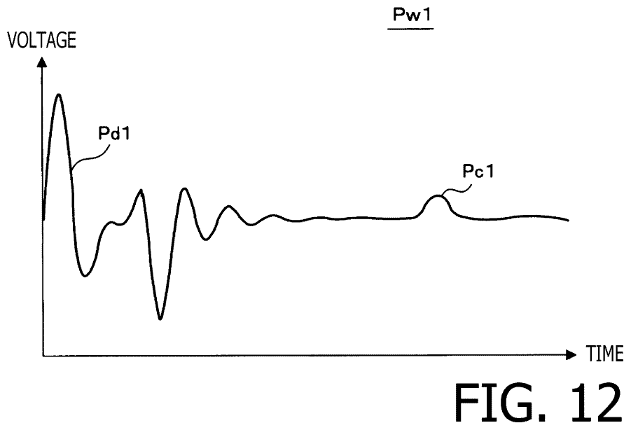

FIG. 12 is a graph schematically showing a corrected drive waveform Pw1. As shown in FIG. 12, the corrected drive waveform generation unit 51g adds a cancel waveform Pc1 to the corrected ejection waveform Pd1 stored in the memory 55 and generates the corrected drive waveform Pw1. The corrected drive waveform Pw1 is stored in the memory 55. The corrected drive waveform Pw1 corresponds to the second drive waveform.

The control circuit 51 executes a flushing process at the time of power-on of the printing apparatus or before executing a printing process, and executes the above-described processing to generate the corrected ejection waveform Pd1 and the corrected drive waveform Pw1. The flushing process is a process in which the carriage 6 is moved to a position above the flushing receiver 21 and ink is ejected from the nozzle 80 to prevent clogging of the nozzle 80, and no printing is performed on the recording sheet 200. When executing a printing process, the control circuit 51 drives the actuator 88 using the corrected drive waveform Pw1. Accordingly, variations in parameters such as amplitude, frequency, and waveform shape of the pressure wave in the pressure chamber 81 can be suppressed, and variations in the condition of the ink ejected from the nozzle 80 such as the ejected ink amount and ejection speed can be reduced. Note that the corrected drive waveform generation unit 51g may use the corrected ejection waveform Pd1 as the corrected drive waveform Pw1 without adding the cancel waveform Pc1 to the corrected ejection waveform Pd1. For example, if the residual pressure wave generated in the pressure chamber 81 by the driving of the corrected ejection waveform Pd1 is small, there is little need to add the cancel waveform Pc1.

The pressure wave output by the pressure wave calculation unit 51d may include both the residual pressure wave and the main pressure wave, which is generated by the actuator 88 being driven by the ejection waveform and propagating through the pressure chamber 81. However, the pressure wave is not limited to this configuration. The pressure wave output by the pressure wave calculation unit 51d may include only the main pressure wave, which is generated by the actuator 88 being driven by the ejection waveform and propagating through the pressure chamber 81, and may not the residual pressure wave.

Although the corrected ejection waveform generation unit 51c was described as repeatedly generating the corrected ejection waveform Pd1 and outputting it to the pressure wave calculation unit 51d until the difference between the target pressure wave W3 and the output of the pressure wave calculation unit 51d, calculated by the calculation unit 51f, becomes equal to or less than a particular value, the corrected ejection waveform generation unit 51c is not limited to this configuration. The corrected ejection waveform generation unit 51c may stop the repeated generation of the corrected ejection waveform Pd1 and its output to the pressure wave calculation unit 51d when the generation and output of the corrected ejection waveform Pd1 have been repeated a particular number of times. Alternatively, the corrected ejection waveform Pd1 may be evaluated, and the generation and output to the pressure wave calculation unit 51d may be stopped when the evaluation value exceeds a particular threshold.

The computer program (program product) may be deployed to be executed on a single computer, or on a computer located at a single site, or on multiple computers distributed across multiple sites and interconnected via a communication network.

The embodiments disclosed herein should be considered as illustrative in all respects and not restrictive. The scope of the present invention is intended to include all modifications within the scope of the claims and all equivalents of the claims. The respective features described in the embodiments can be combined with each other. Further, the independent and dependent claims described in the claims can be combined with each other in any combination, regardless of the form of dependency. Moreover, even if a multiple-dependent claim format is used in the claims, which refers to two or more other claims, the combination of the features is not limited to the dependency. The claims may also be written using a multiple-multiple-dependent claim format, in which a claim refers to another multiple-dependent claim.

What is claimed is:

1. A printing apparatus, comprising:
a nozzle configured to eject liquid from a pressure chamber by an energy applying element;
a controller configured to generate a first drive waveform used to drive the energy applying element, the first drive waveform including an ejection waveform used to eject liquid from the nozzle; and
a detection circuit configured to detect a residual pressure wave in a case where the residual pressure wave occurs in the pressure chamber after the energy applying element is driven based on the first drive waveform;
wherein a detection result from the detection circuit is input to the controller, and
wherein the controller is configured to generate a second drive waveform including a corrected ejection waveform obtained by correcting the ejection waveform based on the detection result from the detection circuit.

2. The printing apparatus according to claim 1,
wherein an amplitude or a frequency of the corrected ejection waveform is different from an amplitude or a frequency of the ejection waveform.

3. The printing apparatus according to claim 1, further comprising:
a storage unit configured to store a model indicating a relationship between the ejection waveform and the residual pressure wave; and
a switch configured to switch between a first connection state where the energy applying element is connected to the controller, and a second connection state where the energy applying element is connected to the detection circuit,
wherein the controller is configured to:
identifies the model in such a manner that residual pressure wave is output after the switch switches a state from the first connection state to the second connection state and the detection circuit detects the residual pressure wave;
output a target pressure wave to be generated in the pressure chamber; and
generate the second drive waveform including the corrected ejection waveform based on the target pressure wave and the model.

4. The printing apparatus according to claim 3,
wherein the model is a second-order delay system model, and
wherein the controller is configured to correct the target pressure wave based on a gain, a damping ratio, and a resonance frequency of the model.

5. The printing apparatus according to claim 4,
wherein the controller is configured to correct the target pressure wave based on a gain, a damping ratio, and a resonance frequency of a fundamental wave of the model, and a gain, a damping ratio, and a resonance frequency of a harmonic wave of the model.

6. The printing apparatus according to claim 4,
wherein the controller is configured to:
generate the corrected ejection waveform based on a difference between the output of the model and the target pressure wave after correcting the target pressure wave based on the gain, the damping ratio, and the resonance frequency of the model.

7. The printing apparatus according to claim 1,
wherein the first drive waveform includes a cancel waveform for attenuating the residual pressure wave, and
wherein the ejection waveform is different from the cancel waveform.

8. A printing method of controlling a printing apparatus where liquid in a pressure chamber is ejected through a nozzle by an energy applying element, the printing method comprising:
generating a first drive waveform used to drive the energy applying element, the first drive waveform including an ejection waveform used to eject liquid from the nozzle;
detecting a residual pressure wave in a case where the residual pressure wave occurs in the pressure chamber after the energy applying element is driven based on the first drive waveform; and
generating a second drive waveform including a corrected ejection waveform obtained by correcting the ejection waveform based on a detection result of the residual pressure wave.

9. A non-transitory computer-readable recording medium containing computer-executable instructions that are executable by a controller of a printing apparatus, the printing apparatus being configured to ejects liquid from a pressure chamber through a nozzle by an energy applying element, the computer-executable instructions being configured to, when executed by the controller, cause the printing apparatus to perform:
generating a first drive waveform used to drive the energy applying element, the first drive waveform including an ejection waveform used to eject liquid from the nozzle;
detecting a residual pressure wave in a case where the residual pressure wave occurs in the pressure chamber after the energy applying element is driven based on the first drive waveform; and
generating a second drive waveform including a corrected ejection waveform obtained by correcting the ejection waveform based on a detection result of the residual pressure wave.
